(19) United States
(12) Patent Application Publication
(10) Pub. No.: US 2020/0160231 A1
(43) Pub. Date: May 21, 2020

(54) Method and System for Using a Multi-Factorial Analysis to Identify Optimal Annotators for Building a Supervised Machine Learning Model

(71) Applicant: International Business Machines Corporation, Armonk, NY (US)

(72) Inventors: Avinash Asthana, London (GB); John F. Pitrelli, Danbury, CT (US); Swami Chandrasekaran, Coppell, TX (US); Edward J. Biddle, Hursley (GB)

(21) Appl. No.: 16/195,084

(22) Filed: Nov. 19, 2018

(51) Int. Cl. G06N 99/00; G06F 17/30; G06N 5/04

(52) U.S. Cl. CPC G06N 99/005; G06N 5/04; G06F 17/30958; G06F 17/30011

(57) ABSTRACT

A method, system, apparatus, and a computer program product are provided for identifying ground truth annotators by applying statistical analyses to a document corpus and to a plurality of annotator profiles to identify, respectively, corpus complexity attributes for the document corpus and annotator qualification attributes for each candidate annotator which are compared with a matching analysis to identify one or more recommended annotators from the plurality of candidate annotators based on the matching analysis.

### BACKGROUND OF THE INVENTION

### Field of the Invention

The present invention relates in general to the field of natural language processing. In one aspect, the present invention relates to using annotators to annotate documents in a supervised machine learning process.

### Description of the Related Art

Supervised machine learning (ML) models are used to extract information from documents, but the process typically relies on humans to annotate documents in a corpus to create a ground-truth data on which the ML model is trained. For a variety of reasons, the reliance on human annotators for creating ML models to extract information extraction can be challenging when analyzing text which is highly complex and uses domain-specific language. Given the time and cost for training a machine-learning model, it is important to train the model with the requisite quality of output required from the human annotators so that it will perform at the desired level. For example, a ML model in the medical domain can require a human annotator to read through dense and technically complex content in a time-efficient manner. To meet the technical requirements for annotating documents in a particular domain or industry area, subject-matter experts (SMEs) having experience in the domain or industry area are typically used to perform document annotation for training the ML model, but such expertise can be expensive to use. It can also be costly to start from scratch or identify new human annotators to do the training annotation work if an annotation project has already started, especially when a new annotator is not guaranteed to be successful. While it might be desirable to always use SMEs or annotators with deep knowledge in the industry (e.g., doctors) to perform such an annotation task, this may not be the most efficient allocation of expensive annotator resources for every annotation task, and such highly skilled (and expensive) annotators are not always available for the work required. And even with highly skilled annotators, the performance of human annotators can vary greatly since the annotation performance quality depends on every individual's understanding of the content, often making it difficult to predict a human annotator's level of performance on the data until well into the task of annotating. While the performance of individual annotators can often be measured by performing some measure of inter-annotator agreement on documents annotated by multiple experts, this imposes both cost and delay in identifying annotators who are well-suited for working with documents in a particular domain. As a result, the existing machine learning solutions are extremely difficult at a practical level since there is no approach available for using a comprehensive set of factors for selecting appropriate human annotator(s) who can train a ML model in a domain area of specified complexity.

### SUMMARY

Broadly speaking, selected embodiments of the present disclosure provide a system, method, computer program product, and apparatus for using a multi-factorial analysis to prioritize and identify one or more human annotators for annotating a corpus used to build a supervised machine learning model for natural language processing in an artificial intelligence system. In selected embodiments, a received corpus of documents in a particular domain is processed using statistical and machine learning analysis to identify high-level concepts and to construct a hierarchical knowledge graph so that the complexity of the corpus documents can be assessed in terms of a first set of extracted parameters and features for the corpus. In similar fashion, a received set of profiles for a candidate set of human annotators is processed using statistical and machine learning analysis, alone or in combination with inter-annotation agreements statistics collected from the candidate set of human annotators, to assess the experience and technical capabilities of each candidate human annotator in terms of a second set of extracted parameters and features for the human annotators. Using the extracted parameters and features, the candidate human annotators are selected on the basis of having the appropriate expertise that is matched to the complexity of the corpus, such as by using weighted scores applied to the annotator attributes (e.g., prior annotation work, writing style, publications, patents, studies, technical domain expertise, publicly expressed areas of interest, personality insights, and relevant past experience) and to the corpus attributes (e.g., term frequency, complexity, and density) to map the human annotators(s) to the identified corpus topic or industry.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a simplified machine language model training system for identifying human annotators who are matched with a corpus for building a machine learning model in accordance selected embodiments of the present disclosure:

FIG. 2 depicts a simplified flow chart showing the logic for identifying qualified annotators by matching corpus complexity to candidate annotator profiles based on a multi-factorial analysis in accordance selected embodiments of the present disclosure; and

FIG. 3 is a block diagram of a processor and components of an information handling system in accordance selected embodiments of the present disclosure.

### DETAILED DESCRIPTION

A method, system, apparatus, computer program product, and apparatus are provided for identifying optimal personnel for annotating a document corpus to build a supervised-machine-learning model by using a multi-factorial analysis to predict how a human annotator may perform in the given domain before the human annotation task begins by matching corpus complexity to candidate annotator profiles, thereby to reduce wasted work of re-doing problematic annotations. In selected embodiments, attributes are gathered from the corpus and candidate annotators by applying a number of statistical and machine-learning techniques to build up a score card that maps the attributes of a group of human annotators to attributes and features of the document corpus to be analyzed. The techniques include clustering of extracted key concepts extracted from the document corpus (and candidate annotator profile information) to determine the dominant domain or industry that the corpus describes. In addition, concept frequency per sentence analysis may be used to determine the complexity and the technical level of the language used within the corpus (and candidate annotator profile information). In addition, statistics on sentence structure and high-level concepts relationships in the corpus (and candidate annotator profile information) may be calculated by applying a relationship detection algorithm. Based on the gathered statistics, a mapping function is applied to match the measures of candidate sophistication in the domain and sophistication of the content in the corpus.

As described herein, embodiments of the present disclosure may be a system, a method, and/or a computer program product. The computer program product may include a non-transitory computer readable storage medium (or media) having computer readable program instructions thereon for causing a processor to carry out aspects of the present invention.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a head disk, a random access memory (RAM), a read-only memory (ROM). an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network (LAN), a wide area network (WAN) and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including LAN or WAN, or the connection may be made to an external computer (for example, through the Internet using an Internet Service Provider). In some embodiments, electronic circuitry including, for example, programmable logic circuitry, field-programmable gate arrays (FPGA). or programmable logic arrays (PLA) may execute the computer readable program instructions by utilizing state information of the computer readable program instructions to personalize the electronic circuitry, in order to perform aspects of the present invention.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical functions. In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

In an embodiment, an apparatus, system and method for generating a domain specific type system are disclosed. With the apparatus, system and method, the qualified annotators are identified by matching corpus complexity to candidate annotator profiles based a multi-factorial analysis.

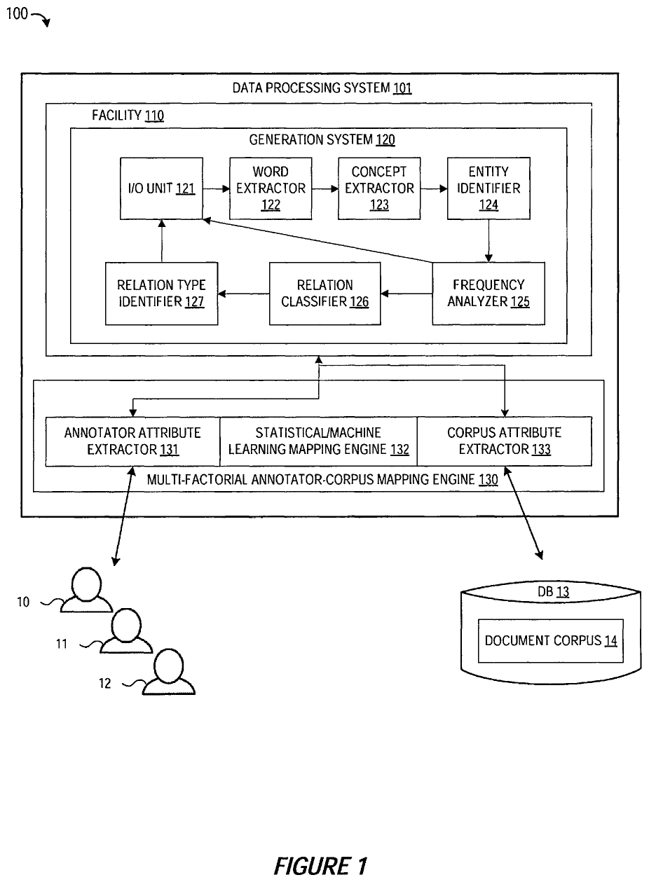

Turning now to FIG. 1, there is depicted a simplified machine language model training system 100 for identifying human annotators 10-12 who are matched with a corpus 14 for building a machine learning model in accordance selected embodiments of the present disclosure. The machine language model training system 100 may be embodied as a data processing system 101, such as a server or client computer in which computer usable code or instructions implementing the process for illustrative embodiments of the present invention are located. In selected embodiments, FIG. 1 represents a server computing device, such as a server, which implements multi-factorial annotator-corpus mapping engine 130 as described hereinbelow.

In the depicted example, the multi-factorial annotator-corpus mapping engine 130 is operating on the data processing system 101 to interact with the facility 110 which can be any tool enabling training of statistical machine learning models for information extraction. For example, the facility can be the IBM Watson Knowledge Studio, etc. running on the data processing system 101. In the depicted example, a generation system 120 is integrated in the machine learning model 110. In another example, the generation system 120 can be separate from the machine learning model 110. In the depicted example, a document corpus 14 that is related to a particular domain is uploaded from a knowledge database 13 into the data processing system 101 (for example, an annotation process manager) so that the multi-factorial annotator-corpus mapping engine 130 can identify one or more human annotators 10-12 who are suitably matched by expertise and capability to the document corpus 14 based on the matching attributes and features from the annotators 10-12 and document corpus 14.

In accordance with selected embodiments of the present disclosure, the multi-factorial annotator-corpus mapping engine 130 is connected to gather and calculate various statistics by applying a plurality of statistical and machine-learning techniques to build up a score card that maps the attributes of a group of human annotators 10-12 to attributes and features of the document corpus 14 to be analyzed. To this end, the multi-factorial annotator-corpus mapping engine 130 includes an annotator attribute extractor 131, a corpus attribute extractor 133, and a statistical/machine learning mapping engine 132.

The annotator attribute extractor 131 is connected and configured to receive candidate human annotator profiles from the candidate human annotators 10-12, which can be collected through an annotator registration process where each annotator provides information, such as the industry, domains and areas of expertise, past annotation experience, and/or sample text from their publications. In addition or in the alternative, the annotator attribute extractor 131 may be connected and configured to continuously or periodically monitor human annotator statistics as they perform human annotation tasks, such as by gathering inter-annotation agreement statistics to identify the number of annotations matching results of adjudication, domain of the annotation process to determine expertise, complexity of the annotated documents, as well as partially-matching and missed annotations.

In similar fashion, the corpus attribute extractor 133 is connected and configured to gather and calculate various statistics identifying attributes of the document corpus 14, such as by applying multiple techniques to the document corpus 14 to extract attributes from the document corpus 14 that can be mapped back to the attributes of the human annotators 10-12. For example, the corpus attribute extractor 133 may use a statistical analysis (e.g., term frequency, cluster analysis, etc.) on the corpus 14 and a knowledge base to identify high-level concepts and to construct a hierarchical knowledge graph of the corpus domain. To this end, the corpus attribute extractor 133 may be connected to the generation system 120 which includes an I/O unit 121, word extractor 122, concept extractor 123, entity type identifier 124, frequency analysis unit 125, relation classifier 126, and relation type identifier 127. The I/O unit 121 is configured to receive the document corpus 14 uploaded by a facility user (for example, an annotation process manager) and to output the generated type system to a runtime for a machine learning end user via a user interface on a display. The word extractor 122 is configured to identify the most frequently occurring words on the document corpus. The concept extractor 123 is configured to extract a conceptual text for each identified word. The entity type identifier 124 is configured to perform a cluster analysis on each conceptual text to identify potential entity types. The frequency analysis unit 125 is configured to perform a frequency analysis on the potential entity types to select entity types used to form the type system. The relation classifier 126 is configured to identify potential relations between entities. The relation type identifier 127 is configured to identify relation types used to form the type system. The relation types identified by the relation type identifier 127 and the entity types identified by the frequency analysis unit 125 are sent to the I/O unit 121 to form the type system which is presented to the machine learning model user. In this way, the extracted clustering of extracted key concepts can be used to determine the dominant domain or industry described in the document corpus 14. Concept frequency per sentence analysis can be used to determine the complexity and the technical level of the language used within the document corpus 14. A higher density of concepts within a sentence suggests that the document is more domain-specific as compared to a low density where the language is probably more general and higher-level. Additional statistics on sentence structure and how high-level concepts are related to other high-level concepts will be calculated by applying the relationship detection algorithm 126.

Using the annotator attribute statistics and corpus annotator statistics, the statistical/machine learning mapping engine 132 assesses the complexity of the document corpus 14 and links the candidate annotator statistics to the features and attributes of the document corpus 14 being annotated so that performance can be evaluated on a per-corpus basis. For example, the statistical/machine learning mapping engine 132 may be configured to match candidate human annotator profiles to the complexity of the corpus, such as by using weighted scores applied to annotator attributes, such as prior annotation work, writing style, publications, patents, studies, domain expertise, and relevant past annotation experience. In addition, statistical/machine learning mapping engine 132 may be configured to assess the complexity of the document corpus 14, such as by using the frequencies of terms at levels of the hierarchical knowledge graph to understand the complexity of terms and the density of occurrence of the terms in the corpus.

As will be appreciated, each unit of the generation system 120 may be implemented on a special purpose hardware-based system, for example the data processing system 101, which performs specified functions or acts or carries out combinations of special purpose hardware and computer instructions to improve the computer functionality in terms of providing a more efficient and accurate machine learning model training system through the prioritization and identification of suitable human annotators who are suitably matched with the document corpus.

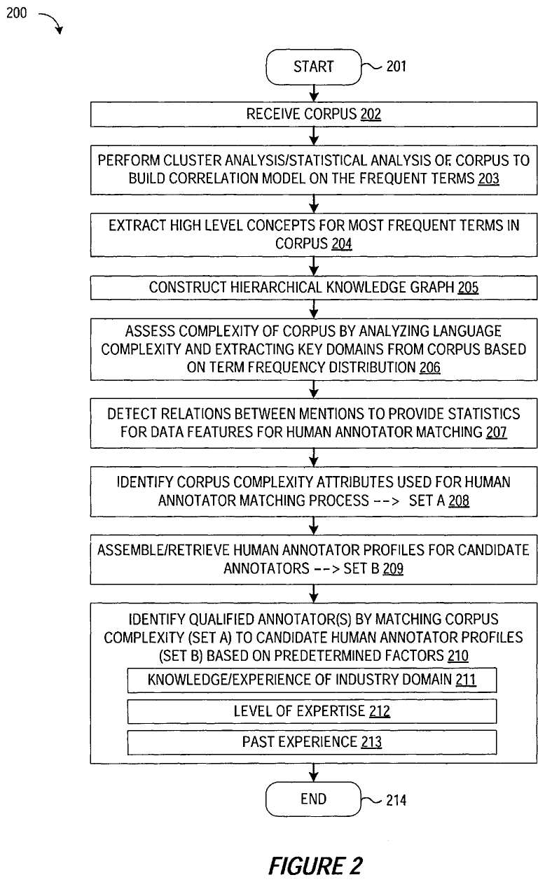

Referring now to FIG. 2, there is depicted an example flow diagram 200 of the logic for identifying qualified annotators by matching corpus complexity to candidate annotator profiles based a multi-factorial analysis in accordance with selected embodiments of the present disclosure. In the flow diagram 200, the method steps may be performed by a programmable natural language processing (NLP) software, hardware and/or firmware to transform the input document corpus 14 and human candidate profile data into a set of statistical features and/or attributes, such as by using a generation system 120 and multi-factorial annotator-corpus mapping engine 130 which are controlled by control logic (e.g., at the data processing system 101) to identify optimal human personnel to annotate data to build a supervised machine learning model. The disclosed methods provide a compact, fast, and accurate mechanism for training a machine learning model with appropriate qualified human annotators.

As a preliminary step, the multi-factorial annotator-corpus mapping process commences at step 201 whereupon the following steps are performed:

Step 202: A document corpus is received. In selected embodiments, an annotation process manager uploads a document corpus into any facility that trains machine learning information extraction classifiers. The document corpus includes a significant number of documents. The facility is any tool enabling training of statistical machine learning models for information extraction. For example, the facility can be IBM Watson Knowledge Studio. Further, in this embodiment, a system for generating the domain specific type system is integrated in the facility.

Step 203: Perform a cluster analysis and build a correlation model on the frequent terms present in the document corpus. In selected embodiments, a natural language processor is applied to extract statistical information from the document corpus, such as by using a generation system (i.e., a system for generating the domain specific type system) to identify the most frequently occurring words on each document of the document corpus, optionally disregarding any stop words, such as “the,” “or,” and “and,” etc. In addition, the system may perform a cluster analysis on each conceptual text extracted from the structured information database to identify possible entity types for the type system. For example, for the extracted conceptual text “Japanese public multinational conglomerate corporation primarily known as a manufacturer of automobiles, aircraft, motorcycles, and power equipment,” a possible entity type “automobile manufacturer” will be identified. In addition, the system may perform a frequency analysis on the identified entity types. Among the potential entity types, the system removes one or more potential entity types that occur less than the predefined number of times within the document corpus. The remaining entity types are used to form the type system. Because the entity types used to form the type system are based on the most frequently occurring words and word sequences on each document of the document corpus, the type system to be formed is relevant to the document corpus, and thus relevant to the specific domain of the document corpus. After the entity types are determined, all the mentions in each document of the document corpus are annotated with the determined entity types. A mention is any span of text in the document corpus that the machine learning model considers relevant to the domain of the document corpus. For example, in a document about automotive vehicles, the terms like “airbag”, “Ford Explorer”, and “child restraint system” might be relevant mentions for the domain.

Step 204: Extract high level concepts for the most frequent terms in the document corpus. In selected embodiments, natural language processing is applied to each word identified at step 203 to look up the most frequent of those terms in an existing structured information database, such as DBpedia, Stanford Encyclopedia, PubMed, Domain ontologies, etc., in order to extract high-level concepts by expanding the ontology provided in the database. For example, if the word “iPhones” was identified in the step 203, the generation system builds a concept hierarchy by navigating up an ontology in DBpedia-iPhone->mobile phone->cellular service->telecommunications industry.

Step 205: Construct a hierarchical knowledge graph. In selected embodiments, the constructed hierarchical knowledge graph is based on the high level concepts and frequent terms extracted by Step 204, and is used to assess the industry and technical complexity of the document corpus by evaluating terms from the corpus based on the depth the term is found within the ontology hierarchical tree. In particular, the system determines where terms extracted from the document corpus occur within the hierarchical tree of the ontology. If terms appear towards the top, then the document is considered to be less complex because the language is focused on a more generic level of terms. In contrast, documents with lots of leaf ontological concepts are deemed to be complex because they are using more specific language.

Step 206: Assess complexity of corpus by analyzing language complexity and extracting key domains from corpus based on term frequency distribution. In selected embodiments, the system uses the term-frequency distributions to assess the complexity of the language and extract key domains represented, such as by using the hierarchical knowledge graph to help determine the language complexity of the document. If the document contains lots of terms that appear deep in the hierarchy tree this will be deemed to be more technical/complex than a document that only mentions terms at the top of the hierarchical tree. This will help to identify the level of technical understanding required from the human annotator for the concepts identified at step 204. If there are high frequency of medical-domain terms throughout the document, this indicates that the corpus is a highly-technical medical document. In contrast, if a medical term occurs every other paragraph, this indicates that while it is about the medical domain, it is not as technical as the earlier example. This will help further refine the kind of human annotator profile required. For example, if a document refers to “Asthma,” this term may appear towards the top of the hierarchical knowledge graph and would be considered to be a basic level of complexity in the medical domain. In contrast, if a document refers to “Chronic Inflammatory diseases,” this would be considered more technical and hence more complex because this term would appear much deeper in the hierarchy of the knowledge graph.

Step 207: Identify relations between mentions to provide relevant statistics for data features for human annotator matching. Based on the information generated at step 206, the system now categorizes the frequency of the identified mentions per sentence and uses a relation detection algorithm that looks at the text before, between, and after two occurrences of mentions within the same sentence to detect relations between mentions. In selected embodiments, the system identifies potential relations between the entities identified in the step 206 by executing a “relation-exists” classifier. The “relation-exists” classifier is a component of a relation detector, and only used to determine whether a relation exists between two entities. The “relation-exists” classifier looks for domain independent cues that predict the existence or non-existence of a relation between two entity types. This classifier views the texts within, before, between, and/or after each pair of entity mentions within a defined distance, such as within the same sentence, and parses features and semantic role labels to detect a relation. The relation identification may involve lexical features of the entities or mentions, and the entity types in the sentence. The lexical features include descriptive units of the entities or mentions, such as noun (N), verb (V), Adjective (A) etc., as well as features reflecting the text, such as letter sequences. In an embodiment, the letter sequences include roots, prefixes, and suffixes. The lexical features and the entity types are domain dependent, and the “relation-exists” classifier may need to be trained, by human trainers, through the document corpus in a specific domain. Furthermore, the system will log the frequency of these relations on a sentence level. To summarize the processing at step 207 pulls out relevant statistics of the kind of features present in the data for further human annotator matching by identifying the most frequently occurring relations, and suggesting a relation type based on the entity types of every two entities or mentions and the words appearing before, between, and/or after every two entities or mentions.

Step 208: Identify corpus complexity attributes used for human annotator matching process. Based on the information generated at steps 203, 206, and 207, the system analyzes the concept hierarchy, technical complexity of the domain, and data attributes contained within the data corpuses, such as entity/relation statistics, occurrences of mentions per sentence etc. that can be referenced back to the human annotator knowledge base. The result of the analysis step 208 will provide attributes of the corpus that are going to be considered for the annotator matching process. In selected embodiments, the attributes identified at step 208 are a first set of critical model points (e.g., Set A) for the document corpus.

In some embodiments, a user interface is provided to allow the machine learning model user to add, view, update, and delete entity types and relation types identified in the preceding steps. Specifically, the machine learning model user can add more entity types and relation types, in addition to the entity types and relation types generated by the generation system. Further, the machine learning model user can view some of or all of the entity types and relation types generated by the generation system. Furthermore, the machine learning model user can revise or update any entity types and relation types generated by the generation system. Moreover, the machine learning model user can delete any entity types and relation types generated by the generation system. In addition, the machine learning model user can adjust the hierarchy of entity types and relation types formed by the generation system.

Step 209: Assemble and/or retrieve the human annotator profiles from the candidate annotators. Using any suitable user interface, each candidate human annotator may be required to go through a registration process to provide predetermined information representing a plurality of factors, including but not limited to the industry, domains and areas of expertise, past annotation experience, writing style, publicly expressed area(s) of interest, sample text from their publications, publications, patents, publishing, studies, and/or personality insights. As part of the registration process, candidates are asked of their profile (age, gender, location, languages expertise) profession, past annotation work (inter-annotator agreement (IAA) score, statistics based on the domain), and area of perceived expertise. These are structured fields for the candidate to complete. In addition or in the alternative, human annotator statistics may be continuously augmented as the annotator(s) perform human annotation tasks. Inter-annotation agreement statistics will be gathered for the number of annotations matching results of adjudication, as well as partially-matching and missed annotations. These statistics will be linked to the features and attributes of the document corpus being annotated so that performance can be evaluated on a per-corpus basis. Once the annotator profile information is assembled, a human annotator database may be used to capture details relevant to the annotation profile. To process the annotator profile information, annotator profile processing steps corresponding to steps 203-207 may then be applied to the annotator profiles to analyze the concept hierarchy, technical complexity of the annotator experience, and data attributes contained within the annotator profiles, such as entity/relation statistics, occurrences of mentions per sentence etc. that can provide attributes of the candidate human annotators that are going to be considered for the corpus matching process. In selected embodiments, the attributes identified at step 209 are a second set of critical model points (e.g., Set B) for the candidate human annotators, such as past domain experience, human annotation performance on a scale of data statistics such as mention/relation frequency per sentence, technical domain expertise, writing style (to compare writing style found in the training data vs. writing style of the candidate human annotator) and area of interest.

Step 210: Identify qualified annotators by matching corpus complexity (Set A) with candidate human annotator profiles (Set B) based on predetermined factors. The match processing may employ any suitable matching tool, such as using a Lightweight Directory Access Protocol (LDAP)-based system for the human annotator database to keep track of the performance of human annotators based on past modelling experience. As disclosed herein, the match processing may apply one or more matching functions between the extracted measures of candidate sophistication in the domain (Set B) and sophistication of the content in the corpus (Set A), including a “knowledge and experience of a particular industry or domain” matching function 211, a “level of expertise” matching function 212, and a “past experience” matching function 213.

As disclosed herein, the “knowledge and experience of a particular industry or domain” matching function 211 may be applied to determine the domain or industry as part of the corpus analysis where extracted key words will be looked up in an ontology and clustered to calculate the dominant domain of the data. The most dominant domains will be compared to the human annotators domain and industry areas of experience which is part of the registration process (e.g., step 209). If the annotator has written publications in the specified domain, that may be considered as well. The matching score would be reduced by domain mismatch of the annotator's writing to the material as gauged. In the case in which the candidate's writing spans multiple domains, the annotator would be re-scored according to the subset of his writings which best match the domain.

In addition, the “level of expertise” matching function 212 may be applied to calculate the technical complexity of the corpus based on the density of domain and industry specific terms contained within each sentence. In selected embodiments, the technical complexity of the corpus will be mapped to the level of expertise registered by the human annotator. And available, the technical complexity of the corpus will be compared to the human annotator's publication analysis. Scored suitability of a candidate annotator is reduced when the corpus complexity measure shows greater sophistication than the annotator's writing, as measured by frequency of use of technical terms and constructions (relations).

In addition, the “past experience” matching function 213 may be applied to analyze the human annotator's historic inter-annotation analysis scores. In selected embodiments, this analysis may focus on past performance analyzing similar domain and language complexity levels. Statistics gathered from the corpus analysis around sentence layout and relationship analysis will form part of this analysis.

To provide additional details of selected embodiments of the present disclosure, consider the example scenario where there are different candidate annotators being evaluated for use in annotating a corpus to create a ground truth, each having different experience and skills. In this example, the candidate annotators could include an experienced clinical language annotator (CLA), an experienced coder, a CLA specialist in procedure, an experienced office/surgical scribe/note-taker, an unemployed physician or doctor, and a medical researcher (e.g., one who wrote research papers but did not treat patients), and an experienced annotator of research papers. In addition, the domain of the corpus in this example includes anonymized patient records which are to be annotated to identify what the doctor is treating including symptoms, diseases, medicines taken, therapies, surgeries, vital signs, allergies, and relations among them.

In operation, a sample of the anonymized patient records is sent to be evaluated by the multi-factorial annotator-corpus mapping engine which processes the patient records to extract corpus features and details, such as key concepts, domains mentioned, writing style, mention/relation density, complexity of the domain based on the technical term frequency within a sentence. These details form the first set of critical model points (e.g., Set A) for the document corpus.

In addition, each candidate annotator completes a registration form and uploads their publications and past annotations to generate annotator details which include their profile, annotation performance, establish domain expertise, and understand writing style and techniques. These details form the second set of critical model points (e.g., Set B) for the candidate annotators.

By comparing the first and second set of critical matching points, the system is configured to look for a plurality of different attributes to identify a team of annotators having different matching profiles. Instead of ending up with an annotation team of one specific profile, the decision flow at the multi-factorial annotator-corpus mapping engine results in the identification of annotators having a range of difference experiences and expertise based on their NLP skills, writing attributes, etc.

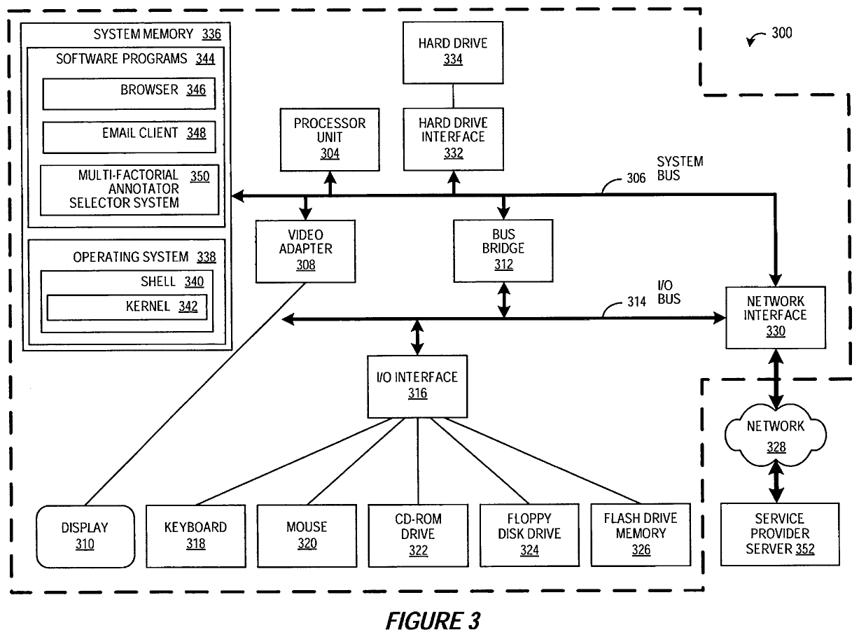

Referring now to FIG. 3, there is depicted is a block diagram of a processor and components of a computer system 300, such as an information handling system, in accordance selected embodiments of the present disclosure. Computer 300 includes one or more processor units 304 that are coupled to a system bus 306. A video adapter 308, which controls a display 310, is also coupled to system bus 306. System bus 306 is coupled via a bus bridge 312 to an Input/Output (I/O) bus 314. An I/O interface 316 is coupled to I/O bus 314. The I/O interface 316 affords communication with various I/O devices, including a keyboard 318, a mouse 320, a Compact Disk-Read Only Memory (CD-ROM) drive 322, a floppy disk drive 324, and a flash drive memory 326. The format of the ports connected to I/O interface 316 may be any known to those skilled in the art of computer architecture, including but not limited to Universal Serial Bus (USB) ports.

Computer 300 is able to communicate with a service provider server 352 via a network 328 using a network interface 330, which is coupled to system bus 306. Network 328 may be an external network such as the Internet, or an internal network such as an Ethernet Network or a Virtual Private Network (VPN). Using network 328, computer 300 is able to use the present disclosure to access service provider server 352.

A hard drive interface 332 is also coupled to system bus 306. Hard drive interface 332 interfaces with a hard drive 334. In selected embodiments, hard drive 334 populates a system memory 336, which is also coupled to system bus 306. Data that populates system memory 336 includes the computer's 300 operating system (OS) 338 and software programs 344.

OS 338 includes a shell 340 for providing transparent user access to resources such as software programs 344. Generally, shell 340 is a program that provides an interpreter and an interface between the user and the operating system. More specifically, shell 340 executes commands that are entered into a command line user interface or from a file. Thus, shell 340 (as it is called in UNIX), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 342) for processing. While shell 340 generally is a text-based, line-oriented user interface, the present invention can also support other user interface modes, such as graphical, voice, gestural, etc.

As depicted, OS 338 also includes kernel 342, which includes lower levels of functionality for OS 338, including essential services required by other parts of OS 338 and software programs 344, including memory management, process and task management, disk management, and mouse and keyboard management. Software programs 344 may include a browser 346 and email client 348. Browser 346 includes program modules and instructions enabling a World Wide Web (WWW) client (i.e., computer 300) to send and receive network messages to the Internet using HyperText Transfer Protocol (HTTP) messaging, thus enabling communication with service provider server 352. In various embodiments, software programs 344 may also include a multi-factorial annotator selector system 350. In these and other embodiments, the multi-factorial annotator selector system 350 includes code for implementing the processes described herein. In one embodiment, computer 300 is able to download the multi-factorial annotator selector system 350 from a service provider server 352.

As will be appreciated, the hardware depicted in FIG. 3 may vary depending on the implementation. Other internal hardware or peripheral devices, such as flash memory, equivalent non-volatile memory, or optical disk drives may be used in addition to or in place of the hardware depicted. Moreover, the data processing system 300 may take the form of a number of different data processing systems, including but not limited to, client computing devices, server computing devices, tablet computers, laptop computers, telephone or other communication devices, personal digital assistants, and the like. Essentially, data processing system 300 may be any known or later developed data processing system without architectural limitation, so other variations are intended to be within the spirit, scope and intent of the present invention.

Selected embodiments of the present disclosure are described with reference to identifying human annotators based on a multi-factorial selection process which evaluates a received corpus of documents and a set of annotator profiles using statistical and machine learning analysis to select human annotators on the basis of having the appropriate expertise that is matched to the complexity of the corpus based on a plurality of predetermined features and/or attributes. However, it will be appreciated that the present disclosure may be also be applied with any factors that are suitable for matching annotators with corpus documents to optimize the selection of annotators to perform the machine learning annotation operations.

By now, it will be appreciated that there is disclosed herein a system, method, computer program code, and apparatus in which data processing system having a processor and a memory storing instructions that are executed by the processor to cause the processor to implement a system for identifying one or more annotators for annotating a document corpus to create a ground truth based on which a model can be trained. The disclosed system, method, computer program code, and apparatus are connected and configured to receiving a document corpus which includes a plurality of documents related to a particular domain. In selected embodiments, the document corpus is received by uploading the document corpus from a knowledge database. In addition, annotator profiles for a plurality of candidate annotators are received, wherein each annotator profile comprises profile data selected from a group consisting of prior annotation history, writing style, technical domain expertise, publicly expressed area of interests, and personality insights for each candidate annotator. In selected embodiments, the annotator profiles are received by uploading annotator registration information selected from the group consisting of annotator age, gender, location, languages, expertise, profession, past annotation work, IAA score, and statistics based on the domain. By applying a first plurality of statistical analyses to the document corpus, corpus complexity attributes for the document corpus are identified. In selected embodiments, the first plurality of statistical analyses is applied by identifying a plurality of frequently occurring words from the document corpus; extracting a conceptual text for each frequently occurring word from a structured information database; performing a cluster analysis on each conceptual text to identify a plurality of possible entity types; performing a frequency analysis on the plurality of possible entity types to select at least one entity type; identifying a relation between entities in the document corpus, wherein a relation is identified between two entities in the document corpus that are related; identifying at least one relation type between the entities in the document corpus, wherein a relation type is identified between two entities based on the entity types of the two entities and a plurality of words appearing within, before, between, or after each pair of entity mentions: and generating, by the processor, the type system including the at least one entity type and the at least one relation type. In addition, a second plurality of statistical analyses is applied to the annotator profiles to identify annotator qualification attributes for each candidate annotator. In selected embodiments, the second plurality of statistical analyses are applied by identifying a plurality of frequently occurring words from each annotator profile; extracting a conceptual text for each frequently occurring word from a structured information database; performing a cluster analysis on each conceptual text to identify a plurality of possible entity types; performing a frequency analysis on the plurality of possible entity types to select at least one entity type: identifying at least one relation between entities in the annotator profiles, wherein a relation is identified between two entities in the annotator profiles; identifying at least one relation type between the entities in the annotator profiles, wherein a relation type is identified between two entities based on the entity types of the two entities and a plurality of words appearing before, between, or after instances of the two entities; and generating the type system including the at least one entity type and the at least one relation type. Subsequently, the disclosed system, method, computer program code, and apparatus apply a matching analysis of the corpus complexity attributes for the document corpus with the annotator qualification attributes for each candidate annotator to identify one or more recommended annotators from the plurality of candidate annotators based on the matching analysis. In selected embodiments, the identification of recommended annotators includes matching the annotator profiles to the document corpus by applying weighted scores to the annotator qualification attributes based on how closely the annotator qualification attributes match the corpus complexity attributes. In addition, the complexity of the corpus may be assessed by constructing a hierarchical knowledge graph of the particular domain for the document corpus based on high-level concepts extracted from the document corpus; and determining a frequencies of terms measure at levels of the hierarchical knowledge graph to evaluate a complexity measure for the terms and density of occurrence of the terms in the document corpus.

While embodiments of the present invention have been shown and described, it will be obvious to those skilled in the art that, based upon the teachings herein, changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer implemented method in a data processing system comprising a processor and a memory, the memory comprising instructions that are executed by the processor to cause the processor to implement a system for identifying one or more annotators for annotating a document corpus to create a ground truth based on which a model can be trained, the method comprising:
receiving, by the processor, a document corpus, wherein the document corpus comprises a plurality of documents related to a particular domain;
receiving, by the processor, annotator profiles for a plurality of candidate annotators, wherein each annotator profile comprises profile data selected from a group consisting of prior annotation history, writing style, technical domain expertise, publicly expressed area of interests, and personality insights for each candidate annotator;
applying, by the processor, a first plurality of statistical analyses to the document corpus to identify corpus complexity attributes for the document corpus:
applying, by the processor, a second plurality of statistical analyses to the annotator profiles to identify annotator qualification attributes for each candidate annotator; and
identifying, by the processor, one or more recommended annotators from the plurality of candidate annotators based on a matching analysis of the corpus complexity attributes for the document corpus with the annotator qualification attributes for each candidate annotator.

2. The method as recited in claim 1, where receiving the document corpus comprises uploading, by the processor, the document corpus from a knowledge database.

3. The method as recited in claim 1, where receiving the annotator profiles comprises uploading, by the processor, annotator registration information selected from the group consisting of annotator age, gender, location, languages, expertise, profession, past annotation work, IAA score, and statistics based on the domain.

4. The method as recited in claim 1, where applying the first plurality of statistical analyses comprises:
identifying, by the processor, a plurality of frequently occurring words from the document corpus;
extracting, by the processor, a conceptual text for each frequently occurring word from a structured information database;
performing, by the processor, a cluster analysis on each conceptual text to identify a plurality of possible entity types;
performing, by the processor, a frequency analysis on the plurality of possible entity types to select at least one entity type;
identifying, by the processor, a relation between two entities in the document corpus that are related;
identifying, by the processor, a relation type between the two entities in the document corpus that are related based on two entity types of the two entities and a plurality of words appearing within, before, between, or after each pair of entity mentions; and
generating, by the processor, the type system including at least one entity type.

5. The method as recited in claim 1, where applying the second plurality of statistical analyses comprises:
identifying, by the processor, a plurality of frequently occurring words from each annotator profile;
extracting, by the processor, a conceptual text for each frequently occurring word from a structured information database;
performing, by the processor, a cluster analysis on each conceptual text to identify a plurality of possible entity types;
performing, by the processor, a frequency analysis on the plurality of possible entity types to select at least one entity type;
identifying, by the processor, a relation between two entities in the annotator profiles that are related;
identifying, by the processor, at least one relation type between the two entities in the annotator profiles that are related based on the entity types of the two entities and a plurality of words appearing before, between, or after instances of the two entities; and
generating, by the processor, the type system including at least one entity type.

6. The method as recited in claim 1, where identifying one or more recommended annotators comprises matching the annotator profiles to the document corpus by applying weighted scores to the annotator qualification attributes based on how closely the annotator qualification attributes match the corpus complexity attributes.

7. The method of claim 1, further comprising:
constructing, by the processor, a hierarchical knowledge graph of the particular domain for the document corpus based on high-level concepts extracted from the document corpus; and
determining, by the processor, a frequencies of terms at levels of the hierarchical knowledge graph to evaluate a complexity measure for the terms and density of occurrence of the terms in the document corpus.

8. An information handling system comprising:
one or more processors;
a memory coupled to at least one of the processors;
a set of instructions stored in the memory and executed by at least one of the processors to identifying one or more annotators for annotating a document corpus, wherein the set of instructions are executable to perform actions of:
receiving, by the system, a document corpus, wherein the document corpus comprises a plurality of documents related to a particular domain;
receiving, by the system, annotator profiles for a plurality of candidate annotators, wherein each annotator profile comprises profile data selected from a group consisting of prior annotation history, writing style, technical domain expertise, publicly expressed area of interests, and personality insights for each candidate annotator;
applying, by the system, a first plurality of statistical analyses to the document corpus to identify corpus complexity attributes for the document corpus;
applying, by the system, a second plurality of statistical analyses to the annotator profiles to identify annotator qualification attributes for each candidate annotator; and
identifying, by the system, one or more recommended annotators from the plurality of candidate annotators based on a matching analysis of the corpus complexity attributes for the document corpus with the annotator qualification attributes for each candidate annotator.

9. The information handling system of claim 8, wherein the set of instructions are executable to receive the document corpus by uploading the document corpus from a knowledge database.

10. The information handling system of claim 8, wherein the set of instructions are executable to receive the annotator profiles by uploading annotator registration information selected from the group consisting of annotator age, gender, location, languages, expertise, profession, past annotation work, IAA score, and statistics based on the domain.

11. The information handling system of claim 8, wherein the set of instructions are executable to apply the first plurality of statistical analyses by:
identifying, by the system, a plurality of frequently occurring words from the document corpus;
extracting, by the system, a conceptual text for each frequently occurring word from a structured information database;
performing, by the system, a cluster analysis on each conceptual text to identify a plurality of possible entity types;
performing, by the system, a frequency analysis on the plurality of possible entity types to select at least one entity type;
identifying, by the system, a relation between two entities in the document corpus that are related;
identifying, by the system, a relation type between the two entities in the document corpus that are related based on entity types of the two entities and a plurality of words appearing before, between, or after instances of the two entities; and
generating, by the system, the type system including at least one entity type.

12. The information handling system of claim 8, wherein the set of instructions are executable to apply the second plurality of statistical analyses by:
identifying, by the system, a plurality of frequently occurring words from each annotator profile;
extracting, by the system, a conceptual text for each frequently occurring word from a structured information database;
performing, by the system, a cluster analysis on each conceptual text to identify a plurality of possible entity types;
performing, by the system, a frequency analysis on the plurality of possible entity types to select at least one entity type;
identifying, by the system, a relation between two entities in the annotator profiles that are related;
identifying, by the system, at least one relation type between the two entities in the annotator profiles that are related based on the entity types of the two entities and a plurality of words appearing before, between, or after instances of the two entities; and
generating, by the system, the type system including at least one entity type.

13. The information handling system of claim 8, wherein the set of instructions are executable to identify one or more recommended annotators by matching the annotator profiles to the document corpus by applying weighted scores to the annotator qualification attributes based on how closely the annotator qualification attributes match the corpus complexity attributes.

14. The information handling system of claim 8, wherein the set of instructions are executable to:
construct, by the system, a hierarchical knowledge graph of the particular domain for the document corpus based on high-level concepts extracted from the document corpus; and
determine, by the system, a frequencies of terms at levels of the hierarchical knowledge graph to evaluate a complexity measure for the terms and density of occurrence of the terms in the document corpus.

15. A computer program product stored in a computer readable storage medium, comprising computer instructions that, when executed by a processor at an information handling system, causes the system to identify one or more annotators for annotating a document corpus by:
receiving, by the processor, a document corpus, wherein the document corpus comprises a plurality of documents related to a particular domain;
receiving, by the processor, annotator profiles for a plurality of candidate annotators, wherein each annotator profile comprises profile data selected from a group consisting of prior annotation history, writing style, technical domain expertise, publicly expressed area of interests, and personality insights for each candidate annotator;
applying, by the processor, a first plurality of statistical analyses to the document corpus to identify corpus complexity attributes for the document corpus;
applying, by the processor, a second plurality of statistical analyses to the annotator profiles to identify annotator qualification attributes for each candidate annotator; and
identifying, by the processor, one or more recommended annotators from the plurality of candidate annotators based on a matching analysis of the corpus complexity attributes for the document corpus with the annotator qualification attributes for each candidate annotator.

16. The computer program product of claim 15, further comprising computer instructions that, when executed by the system, causes the system to receive the annotator profiles by uploading annotator registration information selected from the group consisting of annotator age, gender, location, languages, expertise, profession, past annotation work, IAA score, and statistics based on the domain.

17. The computer program product of claim 15, further comprising computer instructions that, when executed by the system, causes the system to apply the first plurality of statistical analyses by:
identifying, by the processor, a plurality of frequently occurring words from the document corpus;
extracting, by the processor, a conceptual text for each frequently occurring word from a structured information database;
performing, by the processor, a cluster analysis on each conceptual text to identify a plurality of possible entity types;
performing, by the processor, a frequency analysis on the plurality of possible entity types to select at least one entity type;
identifying, by the processor, a relation between two entities in the document corpus that are related;
identifying, by the processor, a relation type between the two entities in the document corpus that are related based on the entity types of the two entities and a plurality of words appearing before, between, or after instances of the two entities; and
generating, by the processor, the type system including at least one entity type.

18. The computer program product of claim 15, further comprising computer instructions that, when executed by the system, causes the system to apply the second plurality of statistical analyses by:
identifying, by the processor, a plurality of frequently occurring words from each annotator profile;
extracting, by the processor, a conceptual text for each frequently occurring word from a structured information database;
performing, by the processor, a cluster analysis on each conceptual text to identify a plurality of possible entity types;
performing, by the processor, a frequency analysis on the plurality of possible entity types to select at least one entity type;
identifying, by the processor, a relation between two entities in the annotator profiles that are related;
identifying, by the processor, at least one relation type between the two entities in the annotator profiles that are related based on the entity types of the two entities and a plurality of words appearing before, between, or after instances of the two entities; and
generating, by the processor, the type system including at least one entity type.

19. The computer program product of claim 15, further comprising computer instructions that, when executed by the system, causes the system to identify one or more recommended annotators by matching the annotator profiles to the document corpus by applying weighted scores to the annotator qualification attributes based on how closely the annotator qualification attributes match the corpus complexity attributes.

20. The computer program product of claim 15, further comprising computer instructions that, when executed by the system, causes the system to:
construct, by the processor, a hierarchical knowledge graph of the particular domain for the document corpus based on high-level concepts extracted from the document corpus; and
determine, by the processor, a frequencies of terms at levels of the hierarchical knowledge graph to evaluate a complexity measure for the terms and density of occurrence of the terms in the document corpus.
